(19) United States
(12) Patent Application Publication
(10) Pub. No.: US 2004/0258312 A1
(43) Pub. Date: Dec. 23, 2004

(54) Method and apparatus for discriminating moving image from still image in plasma display panel

(75) Inventor: Soo Seok Sim, Kumi-shi (KR)

Correspondence Address: FLESHNER & KIM, LLP, P.O. BOX 221200, CHANTILLY, VA, 20153, US

(73) Assignee: LG Electronics Inc.

(21) Appl. No.: 10/869,885

(22) Filed: Jun. 18, 2004

(30) Foreign Application Priority Data
Jun. 20, 2003 (KR) P2003-40120

(51) Int. Cl. G06K 9/00; G06K 9/68

(52) U.S. Cl. 382/219; 382/107

(57) ABSTRACT

A discriminating method and apparatus between a moving image and a still image in a plasma display panel for accurately discriminating a moving image from a still image as well as reducing a deterioration of picture quality is disclosed. In the method and apparatus, an average picture level is independently detected with respect to each data block. Average picture levels detected from said data blocks are compared between frames to discriminate a still image from a moving image.

This application claims the benefit of Korean Patent Application No. P2003-40120 filed in Korea on Jun. 20, which is hereby incorporated by reference.

### BACKGROUND OF THE INVENTION

1. Field of the Invention

This invention relates to a plasma display panel, and more particularly to a discriminating method and apparatus between a moving image and a still image in a plasma display panel that is adaptive for accurately discriminating a moving image from a still image as well as reducing a deterioration of picture quality.

2. Description of the Related Art

Generally, a plasma display panel (PDP) displays a picture by utilizing a visible light emitted from a phosphorus material when an ultraviolet ray generated by a gas discharge excites the phosphorus material. The PDP has advantages in that it has a thinner thickness and a lighter weight in comparison to the existent cathode ray tube (CRT) and is capable of realizing a high resolution and a large-scale screen.

Referring to FIG. 1 and FIG. 2, a conventional three-electrode, AC surface-discharge PDP includes scan electrodes Y1 to Yn and sustain electrodes Z provided on an upper substrate 10, and address electrodes X1 to Xm provided on a lower substrate 18. Discharge cells 1 of the PDP are provided at intersections among the scan electrodes Y1 to Yn, the sustain electrodes Z and the address electrodes X1 to Xm.

Each of the scan electrodes Y1 to Yn and the sustain electrodes Z includes a transparent electrode 12, and a metal bus electrode 11 having a smaller line width than the transparent electrode 12 and provided at one edge of the transparent electrode 12. The transparent electrode 12 is usually formed from indium-tin-oxide (ITO) on the upper substrate 10. The metal bus electrode 11 is usually formed from a metal on the transparent electrode 12 to thereby reduce a voltage drop caused by the transparent electrode 12 having a high resistance. On the upper substrate 10 provided with the scan electrodes Y1 to Yn and the sustain electrodes Z, an upper dielectric layer 13 and a protective film 14 are disposed. Wall charges generated upon plasma discharge are accumulated onto the upper dielectric layer 13. The protective film 14 protects the electrodes Y1 to Yn and Z from a sputtering generated upon plasma discharge, and enhances an emission efficiency of secondary electrons. This protective film 14 is usually made from magnesium oxide (MgO).

The address electrodes X1 to Xm are formed on a lower substrate 18 in a direction crossing the scan electrodes Y1 to Yn and the sustain electrodes. A lower dielectric layer 17 and barrier ribs 15 are formed on the lower substrate 18. A phosphorous material layer 16 is formed on the surfaces of the lower dielectric layer 17 and the barrier ribs 15. The barrier ribs 15 are formed in parallel to the address electrodes X1 to Xm to physically divide the discharge cells 1, thereby shutting off electrical and optical interferences between the adjacent discharge cells 1. The phosphorous material layer 16 is excited and radiated by an ultraviolet ray generated during the plasma discharge to generate any one of red, green and blue visible light rays.

An inactive mixture gas, such as He+Xe, Ne+Xe or He+Ne+Xe, for a discharge is injected into a discharge space defined between the upper/lower substrates 10 and 18 and the barrier ribs 15.

Such a PDP makes a time-divisional driving of one frame, which is divided into various sub-fields having a different light-emission frequency, so as to express gray levels of a picture. Each sub-field is again divided into a reset period for uniformly causing a discharge, an address period for selecting a discharge cell and a sustain period for realizing the gray levels depending on the discharge frequency. For instance, when it is intended to display a picture of 256 gray levels, a frame interval equal to 1/60 second (i.e. 16.67 msec) is divided into 8 sub-fields. Each of the 8 sub-fields is again divided into an address period and a sustain period. Herein, the reset period and the address period of each sub-field are equal every sub-field, whereas the sustain period and the discharge frequency are increased at a ration of 2ⁿ (wherein n=0, 1, 2, 3, 4, 5, 6 and 7) at each sub-field in proportion to the number of sustaining pulses. As the sustain period is differentiated at each sub-field as mentioned above, gray levels of a picture can be implemented.

FIG. 3 schematically shows a driving circuit for the PDP.

Referring to FIG. 3, the driving circuit for the PDP includes a gain adjuster 32, an error diffuser 33 and a sub-field mapping unit 34 connected between a first inverse gamma adjuster 31A and a data aligner 35, and an average picture level (APL) calculator 36 connected between a second inverse gamma adjuster 31B and a waveform generator 37.

Each of the first and second inverse gamma adjusters 31A and 31B makes an inverse gamma correction of digital video data RGB from an input line 30 to thereby linearly convert brightness according to gray level values of image signals.

The gain adjuster 32 adjusts an effective gain for each of red, green and blue data to thereby compensate for a color temperature.

The error diffuser 33 diffuses a quantized error of the digital video data RGB inputted from the gain adjuster 32 into the adjacent cells to thereby make a fine control of a brightness value. To this end, the error diffuser 33 divides the data into a positive number part and a decimal fraction part and then multiplies the decimal fraction part by a Floyd-Steinberg coefficient.

The sub-field mapping unit 34 maps a data from the error diffuser 33 onto a sub-field pattern stored in advance for each bit and applies the mapped data to the data aligner 35.

The data aligner 35 applies digital video data inputted from the sub-field mapping unit 34 to a data driving circuit of the PDP 38. The data driving circuit is connected to the data electrodes of the PDP 38 to latch a data from the data aligner 35 for each one horizontal line and then apply the latched data to the data electrodes of the PDP 38 for each one horizontal period.

The APL calculator 36 detects an average brightness per frame of digital video data RGB inputted from the second inverse gamma adjuster 31B, that is, an average picture level (APL), and outputs information about the number of sustaining pulses corresponding to the detected APL.

The waveform generator 37 generates a timing control signal in response to the information about the number of sustaining pulses from the APL calculator 36, and applies the timing control signal to a scan driving circuit and a sustain driving circuit (not shown). The scan driving circuit and the sustain driving circuit apply a sustaining pulse to the scan electrodes and the sustain electrodes of the PDP 38 during the sustain period in response to the timing control signal from the waveform generator 38.

Meanwhile, there has been suggested a scheme of lowering the number of sustaining pulses to operate the PDP in the residual image mode for the purpose of reducing power consumption when a still image is displayed on the PDP during more than a certain time. To this end, the PDP can include an image discriminating circuit for discriminating a kind of image by calculating a sum of digital video data and comparing the calculated value between frames to discriminate a still image from a moving image. However, such a PDP has a problem in that, since a portion of images can not be accurately discriminated by the conventional moving image/still image discriminating circuit, a picture quality is deteriorated when the PDP is operated in the residual mode with respect to an image that is erroneously discriminated into a still image. For instance, in the case of a scroll image, that is, an image in which a picture field is moved upwardly and downwardly, a sum of digital video data is almost constantly kept even though a picture is moved. This causes the scroll image to be recognized as a still image when digital video data having the scroll image are inputted to the PDP. As a result, if the PDP is operated in the residual image mode, then the scroll image has a low brightness.

### SUMMARY OF THE INVENTION

Accordingly, it is an object of the present invention to provide a discriminating method and apparatus between a moving image and a still image in a plasma display panel that is adaptive for accurately discriminating a moving image from a still image as well as reducing a deterioration of picture quality.

In order to achieve these and other objects of the invention, a discriminating method between a moving image and a still image in a plasma display panel according to one aspect of the present invention includes the steps of (A) dividing data into a plurality of predetermined data blocks; (B) dependently detecting an average picture level with respect to each of said data blocks; and (C) comparing average picture levels detected from said data blocks between frames to discriminate a still image from a moving image.

In the discriminating method, said (C) step includes comparing same data blocks between said frames.

Said (C) step includes comparing the number of data blocks having the same average picture level with a predetermined critical value; and, if the number of data blocks having the same average picture level is more than or equal to said critical value, discriminating a currently input image into a still image.

Otherwise, said (C) step includes comparing the number of data blocks having the same average picture level with a predetermined critical value; and, if the number of data blocks having the same average picture level is less than said critical value, discriminating a currently input image into a moving image.

A discriminating apparatus between a moving image and a still image in a plasma display panel according to still another aspect of the present invention includes a calculator for each block for dividing data into a plurality of predetermined data blocks and for dependently detecting an average picture level with respect to each of said data blocks; and an image discriminator for comparing average picture levels detected from said data blocks between frames to discriminate a still image from a moving image.

In the discriminating apparatus, said image discriminator compares same data blocks between said frames.

Said image discriminator compares the number of data blocks having the same average picture level with a predetermined critical value, and, if the number of data blocks having the same average picture level is more than or equal to said critical value, then discriminates a currently input image into a still image.

Otherwise, said image discriminator compares the number of data blocks having the same average picture level with a predetermined critical value, and, if the number of data blocks having the same average picture level is less than said critical value, then discriminates a currently input image into a moving image.

### BRIEF DESCRIPTION OF THE DRAWINGS

These and other objects of the invention will be apparent from the following detailed description of the embodiments of the present invention with reference to the accompanying drawings, in which:

FIG. 1 is a schematic plan view showing a configuration of a conventional plasma display panel;

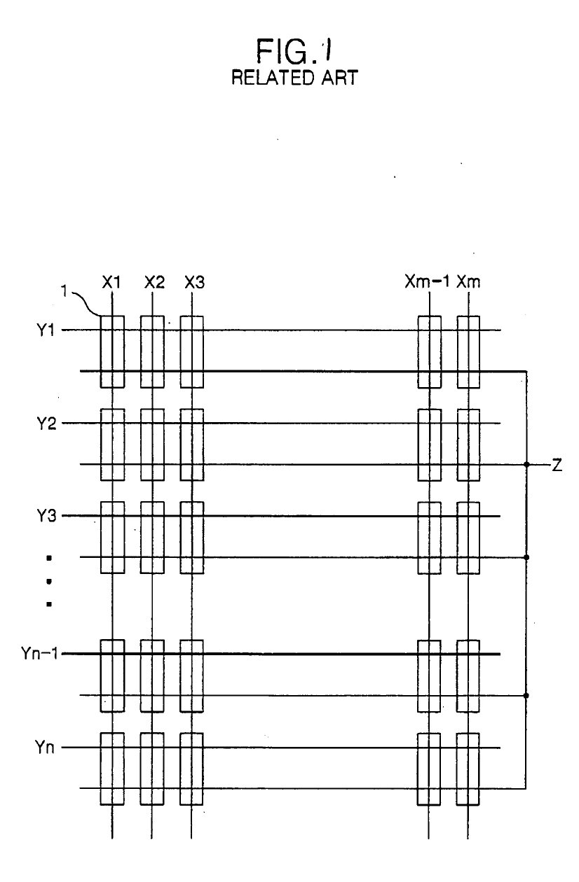

FIG. 2 is a detailed perspective view showing a structure of the cell shown in FIG. 1;

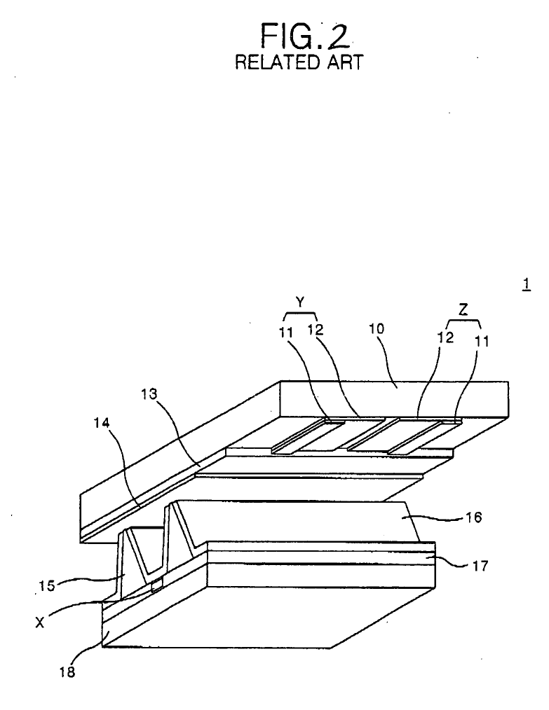

FIG. 3 is a block diagram showing a configuration of a driving circuit for the conventional plasma display panel;

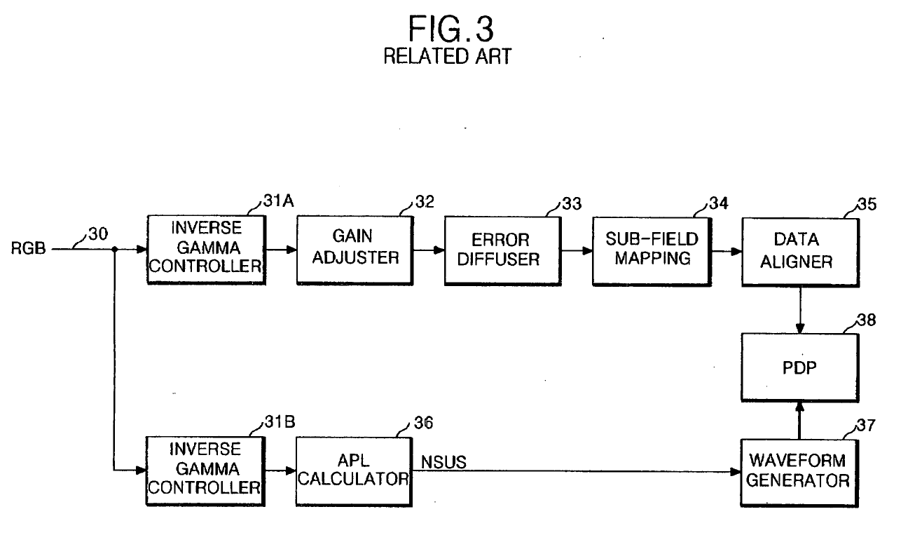

FIG. 4 is a block diagram showing a configuration of a driving circuit for a plasma display panel including a discriminating apparatus between a moving image and a still image according to an embodiment of the present invention;

FIG. 5 is a detailed view of the average picture level calculator for each block shown in FIG. 4;

FIG. 6 is a flow chart showing a control procedure of the image discriminator shown in FIG. 4 step by step; and

FIG. 7 depicts a comparison of the same data block between frames.

### DETAILED DESCRIPTION OF THE EMBODIMENT

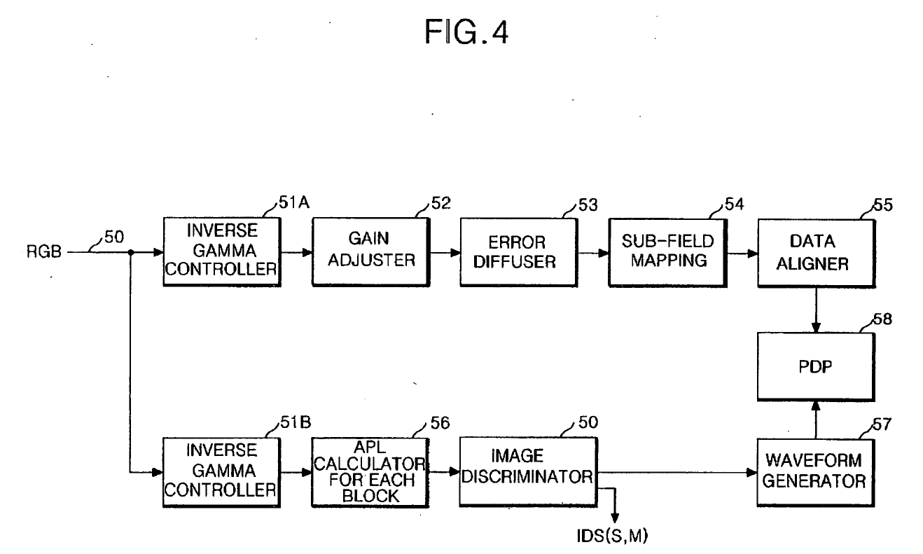

Referring to FIG. 4, a PDP driving apparatus according to an embodiment of the present invention includes a gain adjuster 52, an error diffuser 53 and a sub-field mapping unit 54 that are connected between a first inverse gamma adjuster 51A and a PDP 57, and an average picture level (APL) calculator for each block 56 and an image discriminator 50 that are connected between a second inverse gamma adjuster 51B and a waveform generator 57.

Each of the first and second inverse gamma adjusters 51A and 51B makes an inverse gamma correction of digital video data RGB from an input line 50 to thereby linearly convert brightness according to gray level values of image signals.

The gain adjuster 52 adjusts an effective gain for each of red, green and blue data to thereby compensate for a color temperature.

The error diffuser 53 diffuses a quantized error of the digital video data RGB inputted from the gain adjuster 52 into the adjacent cells to thereby make a fine control of a brightness value.

The sub-field mapping unit 54 maps a data from the error diffuser 53 onto a sub-field pattern stored in advance for each bit, and applies the mapped data to a data aligner 55.

The data aligner 55 applies digital video data inputted from the sub-field mapping unit 54 to a data driving circuit of the PDP 58. The data driving circuit is connected to the data electrodes of the PDP 58 to latch a data from the data aligner 55 for each one horizontal line and then apply the latched data to the data electrodes of the PDP 58 for each one horizontal period.

The APL calculator for each block 56 divides digital video data RGB inputted from the second inverse gamma controller 51B into a plurality of data blocks divided from one picture field, and calculates an average brightness, that is, an APL with respect to each of data blocks. Further, the APL calculator for each block 56 outputs information about the number of sustaining pulses corresponding to the calculated APL.

The image discriminator 50 compares an APL for each block calculated at the previous frame with an APL for each block calculated at the current frame to thereby discriminate a kind of image inputted currently in accordance with the number of blocks in which an APL is differentiated at the previous frame and the current frame. The image discriminator 50 discriminates a currently input image into a still image when the number of blocks having a differentiated APL at the previous frame and the current frame is more than a predetermined threshold value, whereas it discriminates a currently input image into a moving image when the number of blocks having a differentiated APL at the previous frame and the current frame is less than a predetermined threshold value. Further, the image discriminator 50 outputs an image identity signal IDS(S,M) for indicating whether a currently input image is a still image or a moving image in accordance with a logical value differentiated at the still image or the moving image. The image discriminator 50 controls the waveform generator 57 in response to the information about the number of sustaining pulses from the APL calculator for each block 57.

The waveform generator 57 generates a timing control signal in response to the information about the number of sustaining pulses from the image discriminator 50, and applies the timing control signal to a scan driving circuit and a sustain driving circuit (not shown). The scan driving circuit and the sustain driving circuit apply a sustaining pulse to the scan electrodes and the sustain electrodes of the PDF 58 during the sustain period in response to the timing control signal from the waveform generator 57.

The gain adjusting apparatus for each position of the PDP according to the embodiment of the present invention uniforms a brightness difference at the entire field of the PDP with the aid of the gain adjuster 52.

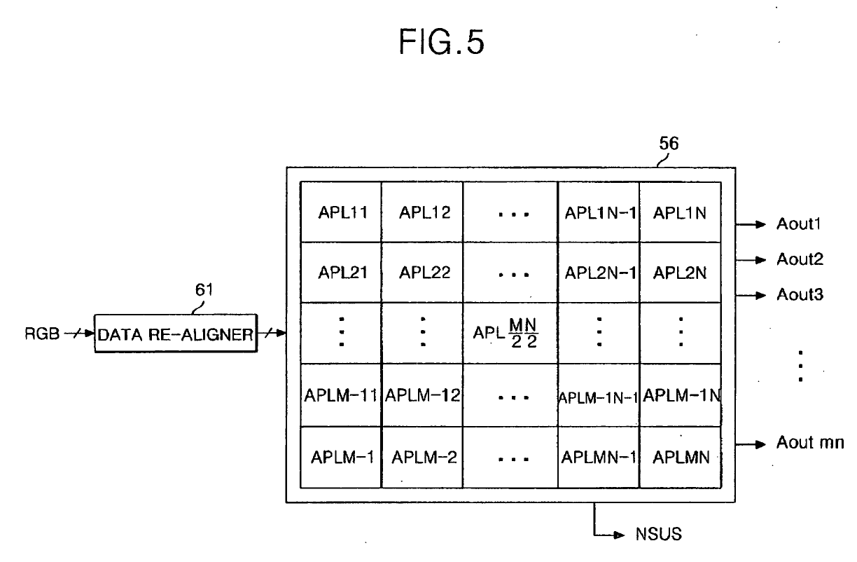

FIG. 5 is a detailed view of the APL calculator 56 for each block.

Referring to FIG. 5, the APL calculator for each block 56 includes a data re-aligner 61 for dividing digital video data RGB into predetermined M×N blocks, and a plurality of APL calculators APL11 to APLMN for calculating an APL independently with respect to each of the data blocks.

M×N gain adjusters GC11 to GCMN for adjusting each gain of data MSK (RGB) divided into the M×N picture blocks.

The M×N blocks set at the data re-aligner 61 are identical to M×N picture blocks divided from the effective field of the PDP. Each of the picture blocks divided from the effective field of the PDP includes a plurality of pixels. The data re-aligner 61 has a frame memory for storing data, and a data separating circuit for separating the data from the frame memory to each picture block.

Each of the APL calculators APL11 to APLMN calculates an APL of each data block to output the calculated values Aout1 to Aoutmn. For instance, the first APL calculator APL11 calculates an APL of data to be displayed on a certain size of first picture area positioned at the left upper side of the screen of the PDP to output the calculated value Aout1. The second APL calculator APL12 calculates an APL of data to be displayed on a certain size of second picture area adjacent to the right side of the first picture area to output the calculated value Aout2

Furthermore, the APL calculator for each block 56 calculates an APL with respect to one picture field, that is, data for one frame, and output information about the number of sustaining pulses NSUS corresponding to the calculated APL for one picture field.

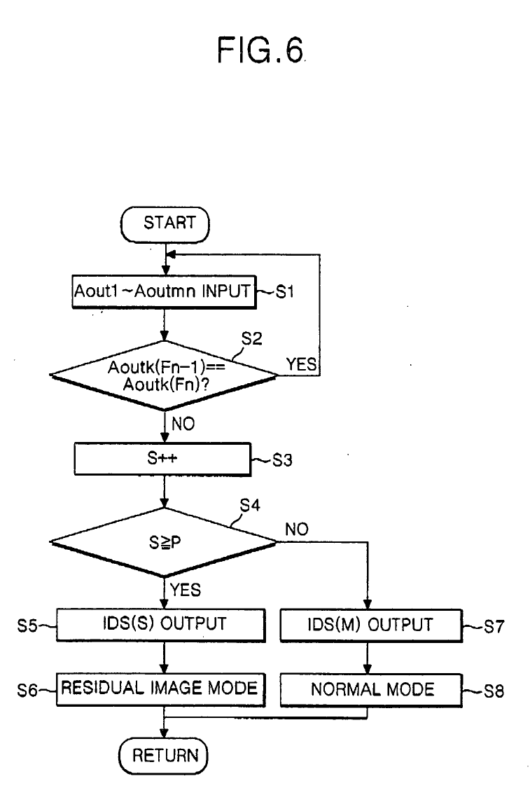

FIG. 6 shows a control procedure of the image discriminator 50.

Referring to FIG. 6, at steps S1 and 52, the image discriminator 50 compares calculated APL values for each block Aout1 to Aoutmn inputted from the APL calculator for each block 56 between the previous frame Fn-1 and the current frame Fn.

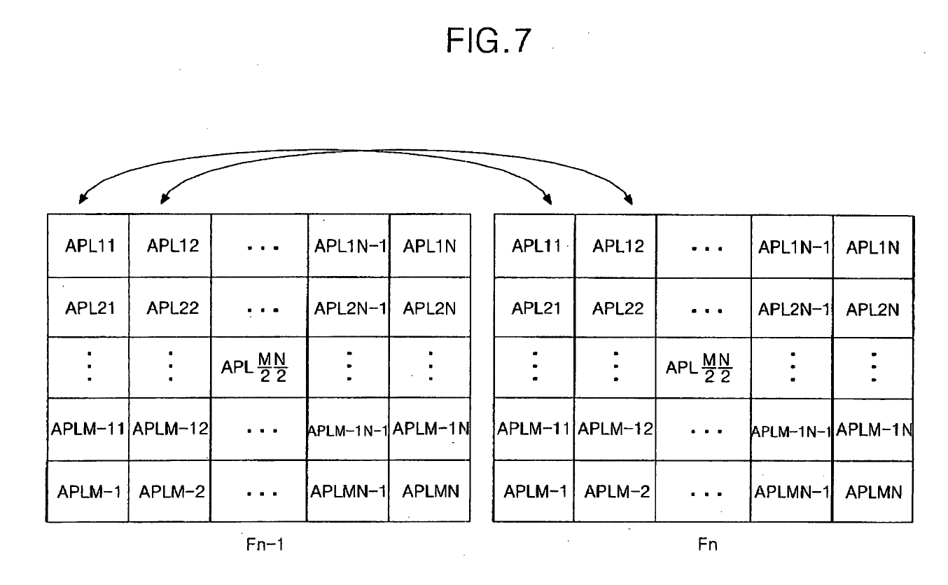

At the step S2, the image discriminator 50 compares calculated APL values of the same data blocks between the previous frame Fn-1 and the current frame Fn as shown in FIG. 7, and determines whether or not the calculated APL values are equal to each other. For instance, the image discriminator 50 determines whether or not a calculated APL value Aout1 of the first data block calculated at the previous frame Fn-1 is equal to a calculated APL value Aout1 of the first data block calculated at the current frame Fn. Further, the image discriminator 50 determines whether or not a calculated APL value Aout2 of the second data block calculated at the previous frame Fn-1 is equal to a calculated APL value Aout2 of the second data block calculated at the current frame Fn.

At a step S3, whenever a data block having the same calculated APL value between the previous frame Fn-l and the current frame Fn is detected, the image discriminator 50 increments an accumulated value S by one. At a step 54, if the accumulated value S is more than or equal to a predetermined critical value P, then the image discriminator 50 discriminates a currently input image into a still image and outputs a signal IDS(S) for identifying the still image. Further, the image discriminator 50 controls the PDP in the residual mode with respect to a currently input image to reduce the number of sustaining pulses.

Otherwise, if the accumulated value S is less than the predetermined critical value P at the step S4, then the image discriminator 50 discriminates a currently input image into a moving image and outputs a signal IDS(M) for identifying the moving image at a step S7. Further, the image discriminator 50 controls the PDP in the normal mode with respect to a currently input image at a step S8 to drive the PDP with the number of sustaining pulses assigned in accordance with each gray level.

Such an image discriminator 50 can be implemented by a program for carrying out the control procedure as shown in FIG. 6, or by a circuitry in which said program is implemented by a memory and a comparing circuit, etc.

The identifying signals IDS(S,M) can be used as a reference signal for controlling the PDP differently with respect to a moving image and a still image. For instance, the present embodiment increases the number of sub-fields in a moving image or differentiates an arrangement of sub-fields in response to the moving image identification signal IDS(M), thereby eliminating a moving-image pseudo contour noise.

As described above, the discriminating method and apparatus between a moving image and a still image according to the present invention divides video data into predetermined data blocks to independently calculate an APL with respect to each data block and compare the calculated APL values for each block between frames, and then discriminates the moving image from the still image in accordance with the compared result. Accordingly, the discriminating method and apparatus according to the present invention makes a discrimination between a moving image and a still image using the existent APL calculator, thereby minimizing an addition of circuits as well as accurately discriminating a moving image from a still image with respect to a particular image such as a scroll image. As a result, it can discriminates a scroll image into a still image, thereby solving a problem in the prior art in that brightness of the scroll image is deteriorated.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A discriminating method between a moving image and a still image in a plasma display panel, comprising the steps of:
(A) dividing data into a plurality of predetermined data blocks;
(B) dependently detecting an average picture level with respect to each of said data blocks; and
(C) comparing average picture levels detected from said data blocks between frames to discriminate a still image from a moving image.

2. The discriminating method as claimed in claim 1, wherein said (c) step includes:
comparing same data blocks between said frames.

3. The discriminating method as claimed in claim 2, wherein said (C) step includes:
comparing the number of data blocks having the same average picture level with a predetermined critical value; and
if the number of data blocks having the same average picture level is more than or equal to said critical value, discriminating a currently input image into a still image.

4. The discriminating method as claimed in claim 2, wherein said (C) step includes:
comparing the number of data blocks having the same average picture level with a predetermined critical value; and
if the number of data blocks having; the same average picture level is less than said critical value, discriminating a currently input image into a moving image.

5. A discriminating apparatus between a moving image and a still image in a plasma display panel, comprising;
a calculator for each block for dividing data into a plurality of predetermined data blocks and for dependently detecting an average picture level with respect to each of said data blocks; and
an image discriminator for comparing average picture levels detected from said data blocks between frames to discriminate a still image from a moving image.

6. The discriminating apparatus as claimed in claim 5, wherein said image discriminator compares same data blocks between said frames.

7. The discriminating apparatus as claimed in claim 6, wherein said image discriminator compares the number of data blocks having the same average picture level with a predetermined critical value, and, if the number of data blocks having the same average picture level is more than or equal to said critical value, then discriminates a currently input image into a still image.

8. The discriminating apparatus as claimed in claim 6, wherein said image discriminator compares the number of data blocks having the same average picture level with a predetermined critical value, and, if the number of data blocks having the same average picture level is less than said critical value, then discriminates a currently input image into a moving image.
